(19) United States
(12) Patent Application Publication
(10) Pub. No.: US 2003/0051210 A1
(43) Pub. Date: Mar. 13, 2003

(54) Device-independent apparatus and method for rendering graphical data

(76) Inventors: Dan L. Collier, Ridgefield, WA (US); Jacob G. Refstrup, Portland, OR (US); Scott E. Silbernagel, Portland, OR (US)

Correspondence Address: HEWLETT-PACKARD COMPANY, Intellectual Property Administration, P.O. Box 272400, Fort Collins, CO, 80527-2400, US

(21) Appl. No.: 09/952,806

(22) Filed: Sep. 13, 2001

(51) Int. Cl. G06F 17/21; G06F 17/24; G06K 15/00

(52) U.S. Cl. 715/507; 715/522; 358/1.18

(57) ABSTRACT

A device for generating graphical output data includes an interface for receiving raw data from a portable device and a template containing at least one graphical instruction. In addition the device includes a processor that merges the raw data with said at least one graphical instruction to obtain merged data, wherein the processor generates raster data from the merged data for transmission to a graphical output system. A method for generating graphical data includes the acts of receiving in a processor a data stream containing at least one object from a portable device and merging the object into a template to obtain merged data. In addition, the method includes generating raster data from the merged data for transmission to a graphical output system.

### TECHNICAL FIELD

The invention relates to formatting and outputting data from an external source, and more particularly to a device-independent method and apparatus for rendering graphical data.

### BACKGROUND OF THE INVENTION

Portable devices, such as cellular phones and personal digital assistants (PDAs), are increasingly popular for storing contact information and calendar information due to the convenience these devices offer. This information is usually stored in vCard and vCal data formats, which are industry-standard, open source formats. Standard formats allow contact and calendar information to be transferred easily between two different devices via, for example, an infrared interface. The standard format also simplifies data transfer between devices from different manufacturers.

While the vCard and vCal formats makes it easy to send, receive, and store information electronically, users may wish to obtain a printed copy of the electronic information as well. Also, while it is possible to interface a portable device with a printer to print contact and/or calendar information stored in the portable device, the resulting printed output tends to contain only the raw contact or calendar data, with minimal formatting changes improving the data's appearance.

Known methods for formatting and printing data from portable devices in a more visually pleasing manner require special applications for creating, viewing and printing the data. Obtaining an output from a graphical output device, such as a video display or printer, often requires a user, device, and/or application to know commands unique to the specific graphical output device being used. Portable device manufacturers have attempted to provide formatted data, but the reduced processing power of portable devices makes sophisticated formatting difficult. Further, if one wants to format data for a video display as well as for a printed output, the limited memory in portable devices makes it difficult for the portable device to store formatting data that would be compatible with a wide variety of different graphical output devices.

### SUMMARY OF THE INVENTION

Accordingly, the present invention is directed to a device for generating graphical output data, comprising an interface for receiving raw data from a portable device, a template containing at least one graphical instruction, and a processor that merges the raw data with said at least one graphical instruction to obtain merged data, where the processor generates raster data from the merged data for transmission to a graphical output system.

The present invention is also directed to a method for generating graphical data, comprising the acts of receiving in a processor a data stream containing at least one object from a portable device, merging the object into a template to obtain merged data, and generating raster data from the merged data for transmission to a graphical output system, such as a printer or a video display.

### BRIEF DESCRIPTION OF THE DRAWINGS

FIG. 1 is a representative diagram illustrating a system incorporating one embodiment of the present invention;

FIG. 2 is a block diagram illustrating an embodiment of the present invention;

FIG. 3 is a block diagram illustrating another embodiment of the present invention;

FIGS. 4a and 4b illustrate one example of vCard data and a resulting unformatted output;

FIG. 5 illustrates one example of merged data; and

FIG. 6 illustrates one example of a graphical output generated from the merged data of FIG. 5.

### DETAILED DESCRIPTION OF THE PREFERRED EMBODIMENTS

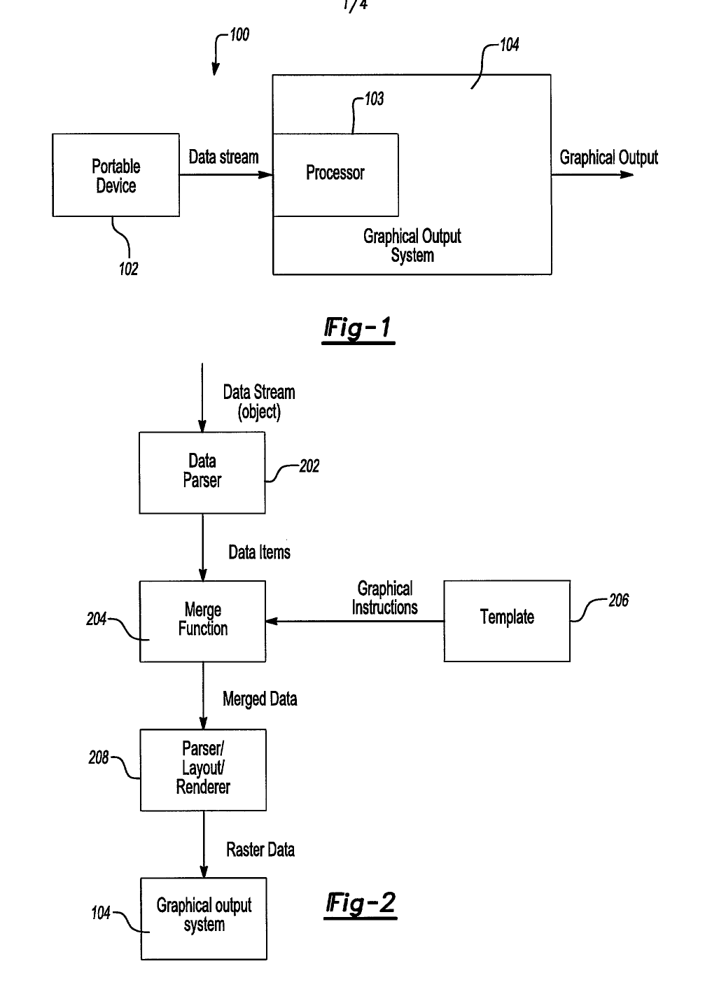

FIG. 1 shows a system 100 incorporating the inventive device and method. A portable device 102, such as a cell phone or personal digital assistant (“PDA”), often contains contact information and/or calendar information for the user's convenience. The contact and calendar information can be stored and transmitted in the vCard and vCal formats, respectively, to allow easy transfer of information between different types of devices (e.g., from a PDA to a cell phone) as well as between devices made by different vendors. Collectively, the vCard and vCal information can be referred to as “vObjects”.

Each vObject contains one or more data items. For example, in a vCard, the data items may include a person's name, address, phone numbers, and e-mail address. If a user wishes to print one or more vObjects using the inventive method, the user transmits the vObject data as a data stream to a processor 103 in a graphical output device 10, such as a printer, for formatting and printing. Because the formatting is conducted in the graphical output system 104, the portable device 102 does not need to contain any formatting data of its own or generate any special graphical syntax to create a formatted output.

Note that although FIGS. 1 and 2 and their corresponding descriptions specifically reference a printer, the graphical output system 104 can be any system of device that can provide a graphical output.

FIG. 2 illustrates one way in which the processor 103 formats an object for graphical output, such as printing or display. The entire process shown in FIG. 2 can be carried out in the printer or other graphical output system 104, freeing memory and processing power in the portable device 102 and allowing the graphical output system 104 to generate uniformly formatted outputs regardless of the portable device's characteristics.

As shown in FIG. 2, a data stream containing one or more objects, such as vObjects, is sent to a data parser 202. The data parser 202 separates the individual data items within the object so that they can be treated as separate entities. To do this, the data parser 202 extracts individual data items, such as a person's name and e-mail address, contained within the object. The parsed data is then sent to a merge function block 204 along with data from a template 206 having graphical instructions for formatting the data's appearance. Because the data received by the data parser 202 is preferably raw data, without formatting instructions, the source of the data does not matter and will not affect the formatting.

The template 206 can be in any form as long as it can accommodate and format the data items via its graphical instructions. In one embodiment, the template 206 is an XHTML-Print template that may contain, for example, optional cascading style sheet information and/or print language constructs. The template 206 contains information that formats the data items in any desired manner by surrounding the data items with XHTML-Print syntax in the merge function block 204. For example, the cascading style sheet may specify the overall appearance and format of the data items, while the print language constructs may specify the formats of individual data items. Other formatting instructions can be included in the template 206 without departing from the scope of the invention. Because the template 206, which conducts the formatting, is separate from the data parser 202 and the data stream itself, the invention isolates the data formatting function from the data acquisition and parsing functions.

This isolation provides printed or displayed outputs with a consistent appearance and format, regardless of the data source. For example, printed objects and data items obtained from a cell phone would have the same appearance as those from a PDA if the same template 206 formats the data from both devices. Further, data items obtained from devices made by different manufacturers would also have the same appearance.

The template 206 also allows the format of the output to be changed by simply changing the style sheet or print language constructs. By changing the template, such as the style sheet information, one can affect the changes of all displayed or printed objects regardless of the object's source.

Using vObject data and an XHTML-Print template in the invention provides further advantages due to their universal open-source nature. The vObject standard establishes a compact data representation that allows easy data transfer between systems and devices. Similarly, the XHTML-Print standard allows any device that can read XHTML-Print syntax to print data formatted in the inventive manner. Using open source standards therefore avoids the need to create a special print or other graphical syntax for formatting data or limiting formatted print data to devices and printers made by specific vendors.

Once the merge function block 204 merges the data items from the data parser 202 and the graphical instructions from the template 206, the resulting merged data is sent to a parser, layout, and renderer 208, which generates raster data from the merged data. The parser, layout and renderer 208 translates the merged data into a form (i.e., the raster data) that the graphical output system 104, such as a printer, can use to generate a formatted output. Thus, rather than requiring the portable device 102 to generate and transmit raster data directly, the invention allows the portable device 102 and the output system 104 to manipulate and format the data according to universal open-source standards. The parser, layout, and renderer 208 then simply reads the merged, formatted data and converts it to raster data.

The data parser 202, template 206, merge function block 204, print parser/layout/renderer 208, and graphical output system 104 can all be located in the printer 104 or any other graphical output device for efficient data formatting and printing. Alternatively, the data parser 202, template 206 and merge function block 204 can be in a processor that is separate from the parser, layout, and renderer 208 and the output system 210, or even outside the parser, layout, and renderer 208 and the output system 104 altogether, so that the generated raster data can be transmitted to any other desired XHTML-Print compliant device for printing or display.

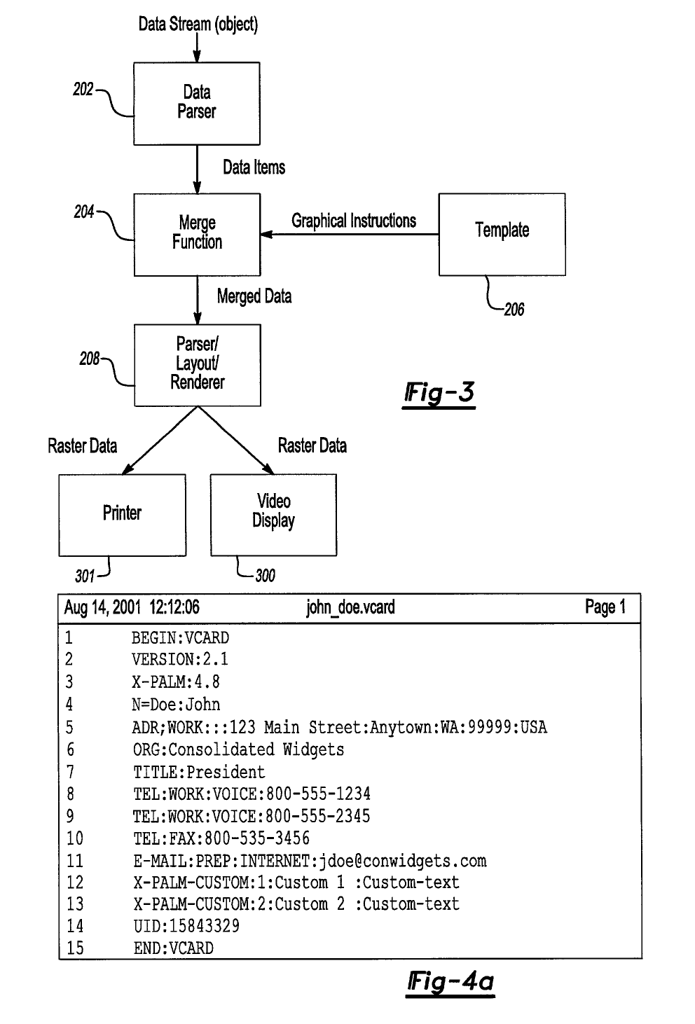

FIG. 3 shows another embodiment of the invention. The embodiment shown in FIG. 3 is generally the same as that shown in FIG. 2, but specifies a video display 300 or a printing system 301 as possible options for the graphical output system 104. The embodiment shown in FIG. 3 therefore provides two graphical output system options for the raster data. Although FIG. 3 shows the availability of both options 300, 301, the invention can include either graphical output option 300, 301 singly without departing from the scope of the invention. If the merged data adheres to the XHTML-Print standard, as explained above, the video display 300 and printer 301 can be any device that can accept raster produced by the parser, layout and renderer 208, which reads and renders XHTML-Print syntax. Thus, the merged data generated according to the invention does not require the printer 301 or the video display 300 to read any proprietary syntax, nor does the portable device 102 need any firmware changes to take advantage of the enhanced graphical capabilities provided by the invention.

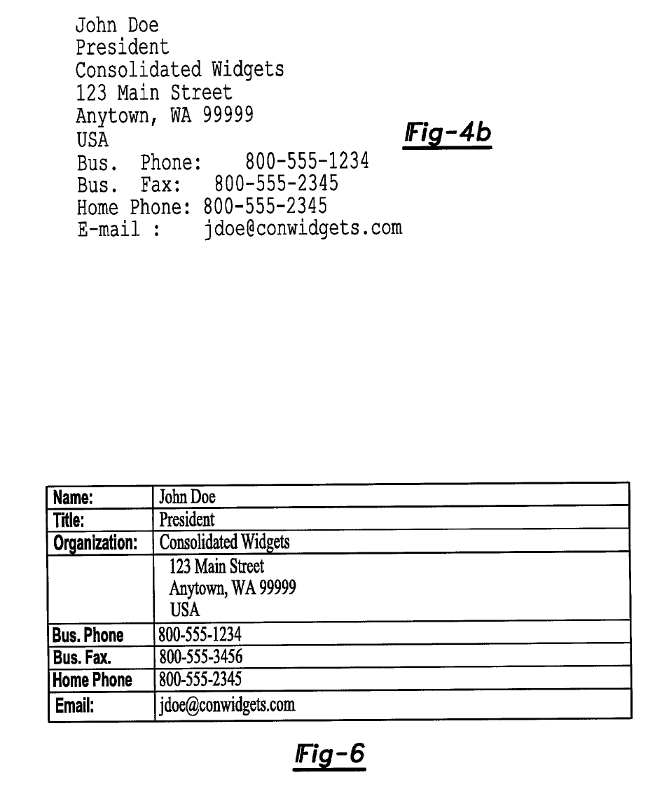

FIGS. 4a and 4b are examples of raw data in an object and a resulting unformatted graphical output generated from the raw data. In this example, FIG. 4a shows raw vCard data items and FIG. 4b shows an unformatted printed output of the vCard data items. As can be seen in FIG. 4b, the output does not contain any formatting or visual enhancers, such as color, shading, lines, labels, font changes, or tables.

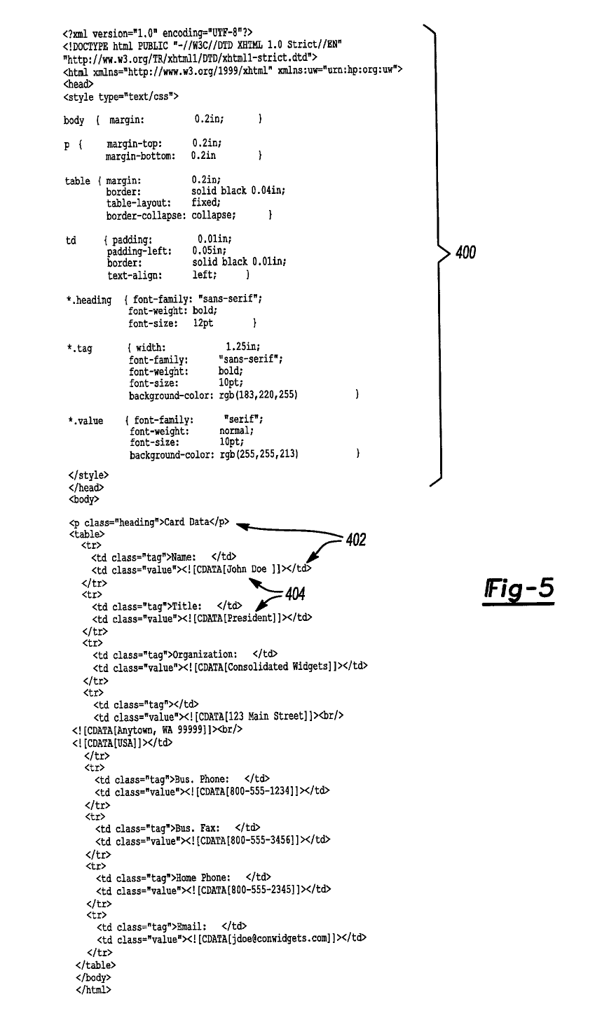

Referring to FIG. 5, the invention improves the appearance of the vCard data in this example by merging the vCard data items of FIG. 4a with an XHTML-Print template. In this example, an optional style sheet 400 describes the overall appearance of the formatted output, while print constructs 402 surround individual data items 404 to format each data item (e.g., name, title, address) within the vCard. Those of skill in the art will understand that FIG. 5 is merely an example and that many variations and combinations of data items, style sheets, and print constructs can be generated and/or omitted without departing from the spirit of the invention.

FIG. 6 illustrates one example of a graphical output generated by the merged data in FIG. 5. The graphical output can be in the form of printed data or a video display. As can be seen in FIG. 5, the merged data generates an enhanced graphical output that is easier for the user to read and understand. Further, significant changes to the overall appearance of the output can be conducted by simply changing the style sheet 400 information and/or the print constructs 402; the user does not need to write new raster data or otherwise make complicated changes to any software or firmware in either the graphical output system 210 or the portable device 102.

The invention therefore allows a graphical output subsystem, such as a printer or video display, to generate a visually pleasing, formatted output regardless of the data source and without requiring the portable device 102 to provide its own formatting instructions to the graphical output system 104. Instead, the formatting data is stored in a combination of the template 206 and the parser, layout and renderer 208 and applied by the output system 104 to any object data and/or data items it receives, regardless of the source or vendor, and uses existing printer resources to generate the raster data. In one embodiment, the invention uses few system resources to obtain a visually pleasing graphical output because the parser, layout, and renderer 208 generates the printable raster data on its own, regardless of data source and without requiring the portable device 102 to provide its own raster data.

Formatting open source (vObject) data according to another open source (XHTML-Print) allows the formatted data to be submitted to a wide variety of XHTML-Print compliant systems while maintaining independence between the printing system and the device providing the vObject data. Formatting vObject data also takes advantage of an industry standard that is already being used by most portable devices. Thus, obtaining formatted print outputs does not depend on compatibility between the device and the graphical output subsystem or the presence of special-purpose instructions in either the device or the subsystem. Additionally, by generating the XHTML-Print data in the printer and not the portable device, portable devices do not need any firmware changes, extra computing power, or extra memory to take advantage of the invention's enhanced formatted printed outputs; all formatting occurs outside of the portable device.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A device for generating graphical output data, comprising:
an interface for receiving raw data from a portable device;
a template containing at least one graphical instruction;
a processor that merges the raw data with said at least one graphical instruction to obtain merged data, wherein the processor generates raster data from the merged data for transmission to a graphical output system.

2. The device of claim 1, wherein the raw data is at least one of a vCard data stream and a vCal data stream.

3. The device of claim 1, wherein said template is an XHTML-Print template.

4. The device of claim 1, wherein the processor includes a parser, layout and renderer to generate the raster data.

5. The device of claim 1, wherein the raw data includes at least one object, and wherein the processor merges the raw data with the template by formatting said at least one object according to said at least one graphical instruction.

6. The device of claim 5, wherein said at least one object contains at least one data item, and wherein the processor formats said at least one data item according to said at least one graphical instruction.

7. The device of claim 6, wherein said at least one graphical instruction includes at least one of a print language construct and an optional style sheet for formatting said at least one data item.

8. The device of claim 1, wherein the graphical output system is a printing system.

9. The device of claim 8, wherein the printing system is located in the device.

10. The device of claim 1, wherein the graphical output system is a video display.

11. A printing device, comprising:
an interface for receiving a data stream having at least one object containing a plurality of data items from a portable device;
a data stream parser that extracts the data items contained within said at least one object;
a template containing at least one of a print language construct and an optional style sheet for formatting the data items;
a processor that merges the template with the data items to obtain merged data, wherein the processor generates raster data from the merged data; and
a printing system that generates a print output from the raster data.

12. The printing device of claim 11, wherein the processor includes a print parser, layout and renderer to generate raster data from the merged data.

13. The printing device of claim 11, wherein the object is at least one of a vCard object and a vCal object, and wherein the print language construct and the optional style sheet are XHTML-Print compliant.

14. A method for generating graphical data, comprising the acts of:
receiving in a processor a data stream containing at least one object from a portable device;
merging the object into a template to obtain merged data; and
generating raster data from the merged data for transmission to a graphical output system.

15. The method of claim 14, further comprising the act of extracting a plurality of data items contained within said at least one object.

16. The method of claim 15, wherein the template contains at least one of a print language construct and an optional style sheet, and wherein the merging act includes the act of formatting the data items with at least one of the print language construct and the optional style sheet.

17. The method of claim 16, wherein the object is at least one of a vCard object and a vCal object, and wherein the print language construct and the optional style sheet are XHTML-Print compliant.

18. The method of claim 14, further comprising the act of transmitting the raster data to the graphical output subsystem.

19. The method of claim 18, further comprising the act of generating a printed output based on the raster data.

20. The method of claim 18, further comprising the act of generating a displayed output based on the raster data.
